(19) United States
(12) Patent Application Publication
(10) Pub. No.: US 2007/0097672 A1
(43) Pub. Date: May 3, 2007

(54) VANITY UNIT

(76) Inventor: Alastair Benn, Herts (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/553,168

(22) Filed: Oct. 26, 2006

(30) Foreign Application Priority Data
Oct. 28, 2005 (GB) 0522004.1

(51) Int. Cl. F21V 33/00

(52) U.S. Cl. 362/135

(57) ABSTRACT

A vanity unit (1) comprises a support frame (3) adapted to be surface mounted to, or inserted into, a receiving component, such as a wall or door, and secured in position, or to be free-standing; a mirror (2) carried by the support frame and forming an outer surface thereof; a flat screen display assembly (10), also carried by the support frame (3), and mounted behind the mirror (2); and at least one user-operable water supply tap associated with the mirror.

### RELATED/PRIORITY APPLICATION

This application claims priority from British Application No. 0522004.1 filed on Oct. 28, 2005.

### FIELD OF THE INVENTION

This invention relates to a vanity unit.

### BACKGROUND OF THE INVENTION

In PCT/GB02/02944 is described a flat screen television unit particularly adapted to be inset into a bathroom wall, with a rectangular portion of the wall chopped out to accommodate a back box, into which is inserted and secured a carrier plate provided at one side with a TV monitor, and at the other side with a glass screen. The carrier plate is secured to the back box by VELCRO™ whilst the screen is secured to the carrier plate by adhesive. Sealant must then be applied around the screen to effect a waterproof seal between the screen and the back box.

In PCT/GB2005/002027 is described an improved construction of flat screen TV unit again intended for bathroom/kitchen etc installation and hence of a waterproof nature, in which inter alia, a magnetic catch arrangement is employed between a mounting plate and an outer glass cover.

### OBJECT OF THE INVENTION

A basic object of the present invention is the provision of a vanity unit.

### SUMMARY OF THE INVENTION

According to the present invention there is provided a vanity unit comprising:

(i) a support frame adapted to be surface mounted to, or inserted into, a receiving component, such as a wall or door, and secured in position, or to be free-standing;

(ii) a mirror carried by the support frame and forming an outer surface thereof; (iii) a flat screen display assembly, also carried by the support frame, and mounted behind the mirror; and

(iv) at least one user-operable water supply tap associated with the mirror.

### ADVANTAGES OF THE INVENTION

The invention provides a vanity unit with a flat screen display assembly behind a mirror, so that the unit has multiple functions as required by the users.

### PREFERRED OR OPTIONAL FEATURES

The support frame is rectangular in front and rear elevation.

The support frame is constructed from lengths of hollow rectangular section tubing

The front wall is provided with a rectangular aperture corresponding at least in part to the area of the display assembly.

Walls of the lengths of tugging of the support frame are apertured to receive at least one water supply pipe to the tap, and also cabling to the display assembly.

The mirror is a conventional mirror.

The mirror is of the kind whereby the display assembly is hidden behind the mirror, remaining virtually invisible until activated by the user.

The mirror has an area the same as that defined by the support frame.

The mirror has a slightly larger area than that defined by the support frame.

The mirror is one piece.

The mirror is assembled from multiple pieces, of size suitable for handling and transportation, particularly where the covering of an entire wall by such a vanity unit is required.

The display assembly occupies a fraction e.g. approximately one third or less, of the mirror area.

Two taps are provided, one for cold water, one for hot water.

A single, mixer tap is provided.

The mirror is secured to the outside of the front wall e.g. by adhesive.

The display assembly is a TV monitor.

The display assembly is a computer monitor.

A waterproof sealant is provided between the mirror and the front wall.

The vanity unit is provided with a water delivery spout connectable to an outlet of the tap(s).

The water spout projects forwardly from the mirror.

The water spout is removable by the user.

The unit is associated with a wash basin.

The unit is associated with a bath.

A manually operable spout control projects forwardly from the mirror.

The vanity unit is provided with a rigid, or flexible shower hose connectable at one end to an outlet of the tap(s) and provided at the other end with shower head.

The vanity unit is provided with lights, particularly in the embodiment with an oversize mirror(s).

The lights are along the sides of the unit.

The vanity unit is provided with speakers.

The speakers are integral.

The speakers are separate.

The vanity unit is provided with one or more operating switches for the display assembly, speakers, etc.

The display assembly is operable by a user-operable remote control unit.

### BRIEF DESCRIPTION OF THE DRAWINGS

FIG. 1 is a front perspective view of a vanity unit in accordance with the invention;

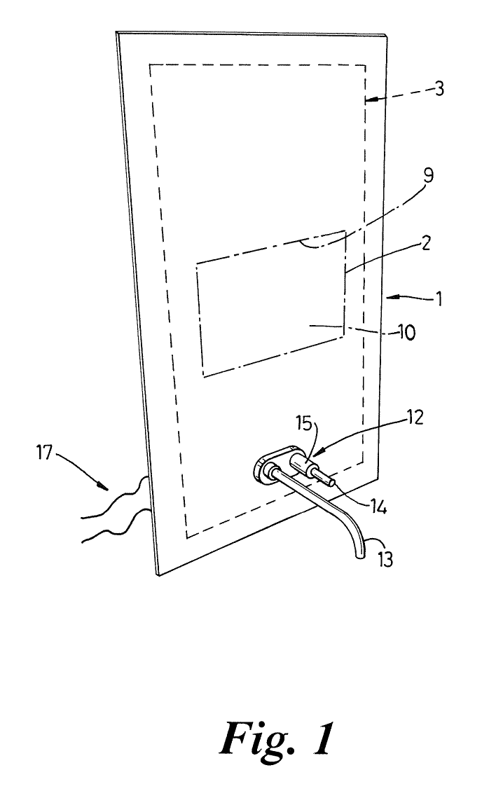

FIGS. 2A, 2B and 2C are respectively a front elevation, a side elevation, a top plan of a support frame of a vanity unit in accordance with the invention, and

FIGS. 3A and 3B are respectively front and side elevations of a tap mounting plate.

### DETAILED DESCRIPTION OF THE DRAWINGS

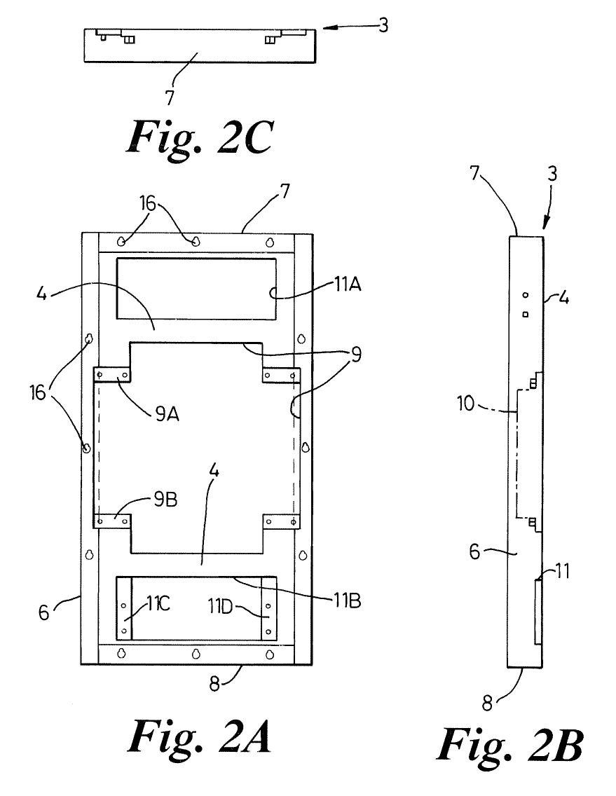

In the drawings, a vanity unit 1 in accordance with the invention comprises basically a rectangular mirror 2 secured to a front surface of a rectangular support frame or chassis 3 detailed in FIGS. 2A to 2C.

The vanity unit 1 is adapted to be either surface mounted on a wall e.g. of a bathroom, or inset into a suitable rectangular recess provided in a wall above a wash basin (not shown) or bathtub (not shown), or could be free-standing.

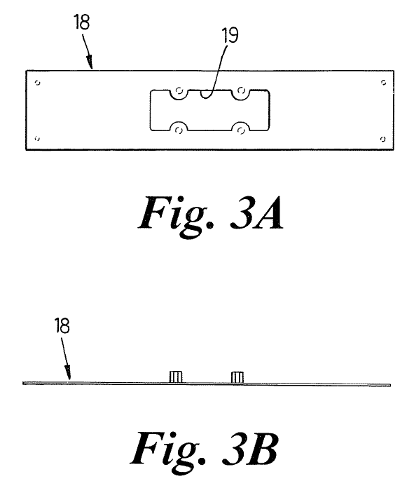

In detail, the support frame 3 is fabricated from hollow, rectangular section metal tubing and comprises a sheet metal front wall or surface 4 separated from a back wall 5 by two interconnecting side walls 6, a top wall 7, and a bottom wall 8. The front wall 4 is provided with a cruciform aperture 9 of dimensions corresponding generally to those of a flat screen TV monitor 10 (FIG. 2B), which is mounted on the frame 3 by suitable means such as by nuts onto studs or screws/bolts. In the example illustrated, the aperture 9 and monitor 10 extend a relatively small proportion e.g. one third of the total area of the vanity unit 1. As can be seen in FIG. 2A, the front wall 4 is also provided with an upper rectangular aperture 11A for weight saving and a lower rectangular aperture 11B across which is fixed, by screws, the mounting plate 18 of FIGS. 3A and 3B, having an opening 19 for the mounting of a mixer tap unit 12 comprising a forwardly projecting water discharge spout 13 and a user-operable, multi-position rod 14 of a valve 15 to provide on, off, hot and cold positions, as required by the user. Clearly, the mirror 2 is also required to have an aperture of similar shape and dimensions to the opening 19, so that portions of the spout 13, valve 15 and rod 14 may project through the mirror 2, the latter being secured by screws over the front wall 4 of the frame 3.

The support frame 3 illustrated is intended to be surface mounted, and for this purpose a rear face is provided with three spaced-apart keyhole apertures 16 so that the unit 1 may be engaged over the heads of three suitably spaced screws (not shown) fixed into the bathroom etc wall, whilst cabling for both electrical power and signal to the monitor 10 is indicated at 17, and clearly hot and cold water supplies are required to the valve 15.

FIG. 2A indicates “portrait” mounting, but a customer, or installation constraints, may require “landscape” mounting by turning the support frame 3 of FIG. 2A through 90°. In this case, the tap mounting plate 18 would be screwed across portions 9A and 9B of the aperture 9, rather than across portions 11C and 11D of aperture 11B.

1. A vanity unit comprising:
(i) a support frame adapted to be surface mounted to, or inserted into, a receiving component, such as a wall or door, and secured in position, or to be free-standing;
(ii) a mirror carried by said support frame and forming an outer surface thereof;
(iii) a flat screen display assembly, also carried by said support frame, and mounted behind said mirror; and
(iv) at least one user-operable, water supply tap associated with said mirror.

2. A unit as claimed in claim 1, wherein said support frame is rectangular in front and rear elevation.

3. A unit as claimed in claim 1, wherein said support frame is constructed from lengths of hollow rectangular section tubing

4. A unit as claimed in claim 3, wherein a rectangular aperture is provided in a front wall of said support frame, said rectangular aperture corresponding, at least in part, to the area of said display assembly

5. A unit as claimed in claim 3, wherein the walls of said lengths of tubing of said support frame are apertured to receive at least one water supply pipe to said tap, and also cabling to said display assembly.

6. A unit as claimed in claim 1, wherein said mirror is a conventional mirror.

7. A unit as claimed in claim 1, wherein said mirror is of the kind whereby said display assembly is hidden behind said mirror, remaining virtually invisible until activated by a user.

8. A unit as claimed in claim 1, wherein said mirror has an area the same as that defined by said support frame.

9. A unit as claimed in claim 1, wherein said mirror is one piece.

10. A unit as claimed in claim 1, wherein said mirror is assembled from multiple pieces, of size suitable for handling and transportation, particularly where the covering of an entire wall by such a vanity unit is required.

11. A unit as claimed claim 1, wherein said display assembly occupies a fraction e.g. approximately one third or less, of the said mirror.

12. A unit as claimed in claim 1, wherein two of said taps are provided, one for cold water, one for hot water.

13. A unit as claimed in claim 1, wherein a single, mixer tap is provided.

14. A unit as claimed in claim 1, wherein said mirror is secured to said outside of the front wall by screw means and/or by adhesive.

15. A unit as claimed in claim 1, wherein said display assembly is a TV monitor.

16. A unit as claimed in claim 1, wherein said display assembly is a computer monitor.

17. A unit as claimed in claim 1, wherein a waterproof sealant is provided between said mirror and said support frame.

18. A unit as claimed in any preceding claim, provided with a water delivery spout connectable to an outlet of said tap(s).

19. A unit as claimed in claim 18, wherein said water spout projects forwardly from said mirror.

20. A unit as claimed in claim 19, wherein said water spout is removable by a user.

21. A unit as claimed in claim 1, provided with a rigid, or flexible shower hose connectable at one end to an outlet of said tap(s) and provided at the other end with shower head.

22. A unit as claimed in claim 1, provided with lights.

23. A unit as claimed in claim 22, wherein said lights are along the sides of the unit.

24. A unit as claimed in claim 1, provided with audio speakers.

25. A unit as claimed in claim 24, wherein said speakers are integral.

26. A unit as claimed in claim 24, wherein said speakers are separate.

27. A unit as claimed in claim 1, provided with one or more operating switches.

28. A unit as claimed in claim 1, wherein said display assembly is operable by a user-operable remote control unit.
